(19) United States
(12) Patent Application Publication
(10) Pub. No.: US 2025/0011091 A1
(43) Pub. Date: Jan. 9, 2025

(54) CONVEYOR BELT AND METHOD TO PRODUCE IT

(71) Applicant: ALFABELTS S.R.L., Vobarno (BS) (IT)

(72) Inventor: Leonardo Alberti, Vobarno (BS) (IT)

(73) Assignee: ALFABELTS S.R.L., Vobarno (BS) (IT)

(21) Appl. No.: 18/711,288

(22) PCT Filed: Nov. 18, 2022
(86) PCT No.: PCT/IT2022/050298

§ 371 Date: May 17, 2024

(30) Foreign Application Priority Data
Nov. 19, 2021 (IT) 102021000029396

(51) Int. Cl. B65G 15/34; B32B 5/02; B32B 25/04; B32B 27/06; B32B 37/10; B32B 38/08

(52) U.S. Cl. CPC B65G 15/34; B32B 5/024; B32B 5/028; B32B 25/04; B32B 27/06; B32B 37/10; B32B 38/08; B32B 2260/021; B32B 2260/046; B32B 2260/048; B32B 2262/0261; B32B 2262/0276; B32B 2262/062; B32B 2305/38; B32B 2307/51; B32B 2307/54; B32B 2307/546; B32B 2433/02

(57) ABSTRACT

Conveyor belt (10) comprising a first layer (11) configured to support objects, a second layer (12) underlying the first layer (11), a mesh net (13) disposed, or embedded, at least partially, inside the second layer (12) and a third layer (20) adhering to the second intermediate layer (12) and comprising at least one reinforcing material (21).

### FIELD OF APPLICATION

The present invention relates to a conveyor belt for a motorized conveyor, which can be applied, for example but without limitation to the generality, in the sector of the production of corrugated cardboard for the handling of semi-finished cardboards, or in the sector of wood processing for the handling of wooden boards.

### BACKGROUND ART

In the corrugated cardboard production sector, or in the woodworking sector, but not only, the use of motorized conveyors for the transport of objects that need to be handled, for example along production lines, is known.

Such motorized conveyors comprise a series of rollers which move a conveyor belt closed in a loop around the latter and on which the objects to be handled are disposed.

Typically, a conveyor belt of known type comprises a first layer of rubber to support the objects to be handled and a second layer of rubber in which a mesh net is embedded.

Such known conveyor belt, although appreciated for having a high tensile strength and at the same time allowing to facilitate the operations for its implementation, has some drawbacks.

In particular, a first drawback is that the known conveyor belt, during use, is subject to a high elongation which can surpass even 10% of its overall length.

Such elongation is caused both by the mechanical stresses to which it is subjected, and by the thermal expansions due to the temperatures that it reaches, by friction, during use.

A further drawback is that, after some cycles of use, the lateral portions of the known conveyor belt tend to elongate more than the central portion thereof. This leads to the loss of the original planar shape of the conveyor belt and gives it a wavy shape at its lateral edges.

Document JP 2017 100848 discloses a belt for use in a twisted state, such as a belt for winding a paper tube and a method for manufacturing the same.

Document US 2003/155215 discloses a reinforcing band for conveyor belts and conveyor belt using the same.

Document U.S. Pat. No. 5,938,007 A discloses a conveyor belt and a method for forming the belt itself.

Document EP 0.489.694 A1 discloses a process belt, for example used for automatic operations, in particular in the textile industry, in particular as a printing base in planographic, rotary, roller and the like printing machines.

Document JP 2008 162803 A discloses a reinforced belt, in particular used in “powerturn” applications, in which the conveyor belt does not travel in a straight path parallel to its longitudinal length.

Document CN 113.581.741 A discloses a tubular conveyor belt with steel wire core.

Therefore, there is a need to improve a conveyor belt and a relative production method, which can overcome at least one of the drawbacks of the prior art.

To do this, it is necessary to solve the technical problem of increasing the rigidity of the conveyor belt.

In particular, an object of the present invention is to produce a conveyor belt which, in use, is subject to a reduced longitudinal elongation.

Another object of the present invention is to produce a conveyor belt which has a high transverse rigidity and which maintains its original planar shape over time, even after several work cycles.

A further object of the present invention is to realize a conveyor belt that is inexpensive and easy to produce.

In order to overcome the drawbacks of the prior art, and to obtain the above as well as further objects and benefits, the Applicant has studied, tested and realized the present invention.

### DISCLOSURE OF THE INVENTION

The present invention is expressed and characterised in the independent claims. The dependent claims show other features of the present invention or variants of the main solution proposed.

In accordance with the aforesaid purposes and to solve the aforesaid technical problem in a new and original way, also obtaining considerable advantages with respect to the prior art, a conveyor belt for transporting one or more objects, according to the present invention comprises a first layer configured to support the aforesaid one or more objects, a second layer associated with the aforesaid first layer, and a mesh net disposed, or embedded, at least partially, inside the aforesaid second layer.

In accordance with an aspect of the present invention, the aforesaid conveyor belt also comprises a third layer adhering to the aforesaid second layer, on the opposite side with respect to the aforesaid first layer and comprising at least one reinforcing material.

In accordance with another aspect of the present invention, the aforesaid reinforcing material comprises, or consists of, a fabric.

In accordance with another aspect of the present invention, the aforesaid reinforcing material is disposed, or embedded, at least partially in a gripping material comprising, or consisting of a natural and synthetic rubber, selected from a group that comprises natural and synthetic elastomers or NBR, SBR, EPDM/EPM, NR, CR, FKM, IIR, XIR, CSM, XNBR, HNBR rubber, silicone rubber, polyurethane and PVC.

In accordance with another aspect of the present invention, the aforesaid fabric comprises a plurality of first yarns and a plurality of second yarns intertwined with the aforesaid first yarns. In addition, the aforesaid first yarns are more rigid than the aforesaid second yarns.

In accordance with another aspect of the present invention, the aforesaid first yarns are disposed in the direction of the width of the aforesaid conveyor belt and the aforesaid second yarns are disposed in the direction of the length of the aforesaid conveyor belt, perpendicular to the aforesaid direction of the width.

In embodiments, the aforesaid fabric is formed by yarns of natural fibres or synthetic fibres or artificial fibres or combination thereof.

In embodiments, the aforesaid natural fibres are cotton fibres.

In embodiments, the aforesaid synthetic fibres are polyester and/or nylon fibres.

In accordance with another aspect of the present invention, the aforesaid first yarns are made of polyester and/or nylon and have a first diameter comprised between about 0.05 mm and about 1.2 mm and the aforesaid second yarns are made of polyester and/or nylon and have a second diameter comprised between about 0.05 mm and about 1.2 mm.

In accordance with another aspect of the present invention, the aforesaid conveyor belt also comprises a fourth layer adhering to the aforesaid third layer, on the opposite side with respect to the aforesaid second layer and configured to contact means for advancing the aforesaid conveyor belt.

In accordance with a further aspect of the present invention, a method to produce a conveyor belt comprises the following steps:
a first step in which the aforesaid third layer is disposed on a supporting plane;
a second step in which the aforesaid second layer is disposed on the aforesaid third layer;
a third step in which the aforesaid mesh net is coupled to at least the aforesaid second layer;
a fourth step in which the aforesaid first layer is superimposed on the aforesaid second layer and/or the aforesaid mesh net;
a fifth step in which the aforesaid first layer, the aforesaid second layer, the aforesaid mesh net and the aforesaid third layer are pressed hot against each other.

In accordance with another aspect of the present invention, the method also envisages an impregnation step, preceding the aforesaid first step, wherein the aforesaid reinforcing material is impregnated with a gripping material comprising, or consisting of, a rubber, either natural or synthetic, selected from a group that comprises natural or synthetic elastomers or NBR, SBR, EPDM/EPM, NR, CR, FKM, IIR, XIR, CSM, XNBR, HNBR rubber, silicone rubber, polyurethane and PVC.

In accordance with another aspect of the present invention, in the aforesaid fifth step a pressure is applied comprised between about 6 kg/cm² and about 12 kg/cm², the aforesaid layers being heated to a temperature comprised between about 130° C. and about 170° C. for a time comprised between about 5 seconds and about 30 minutes.

In accordance with a further aspect of the present invention, a motorized conveyor comprises at least one conveyor belt as described herein, or obtained by a method as described herein, disposed endlessly around and at least two respective rollers of the aforesaid motorized conveyor.

According to embodiments, the aforesaid conveyor belt is wound in a loop around said at least two rollers. In essence, the motorized conveyor includes at least two rollers, around which the aforesaid conveyor belt is wound in a loop.

According to embodiments, the aforesaid conveyor belt is disposed in a planar manner, without longitudinal twists, in said motorized conveyor.

### ILLUSTRATION OF THE DRAWINGS

These and other aspects, features and advantages of the present invention will become clear from the following disclosure of some embodiments, provided merely by way of non-limiting example only, with reference to the accompanying drawings in which:

FIG. 1 is an axonometric view of a portion of a conveyor belt in accordance with the present invention;

FIGS. 2 and 3 are sectional views in plane II-II of a conveyor belt in accordance with two embodiments of the present invention;

FIG. 4 is a top view of a part of the conveyor belt according to the present invention;

FIG. 5 is a top view of another part of the conveyor belt of the present invention;

FIG. 6 is a schematic view of a machine to produce a conveyor belt in accordance with a method of making in accordance with the present invention;

FIGS. 7 and 8 are two enlargements of FIG. 6;

FIG. 9 is a schematic view of a motorized conveyor in accordance with the present invention.

It should be noted that, in the present disclosure, the phraseology and terminology used, as well as the figures in the accompanying drawings, even as disclosed, have the sole purpose of illustrating and explaining the present invention, since their function is illustrative and not limited to the invention itself, the scope of protection thereof being defined by the claims.

To facilitate understanding, identical reference numbers have been used, where possible, to identify identical common elements in the figures. It should be noted that elements and features of an embodiment can be conveniently combined or incorporated into other embodiments without further clarification.

### DESCRIPTION OF EMBODIMENTS

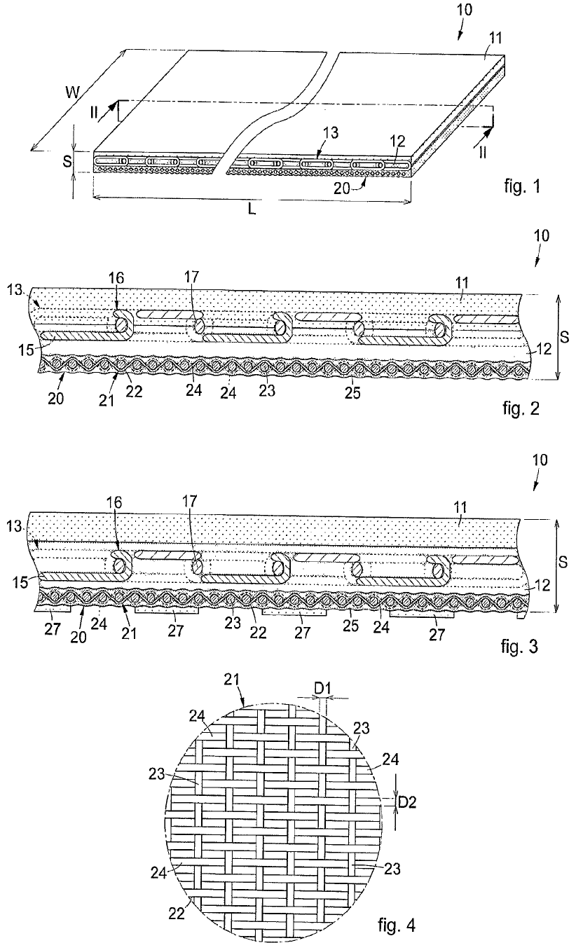

FIG. 1 is used to describe embodiments of a conveyor belt 10.

Such belt 10 can be used as a conveyor belt in the corrugated cardboard production sector for handling semi-finished or “blank” corrugated cardboard, or in the woodworking sector for handling wooden boards. To this end, the belt 10 described herein is generally disposed in a planar manner, without longitudinal twists.

The belt 10 has a substantially flat and oblong shape and has a length L, a width W and a thickness S.

The length L is much greater than the width W and the thickness S and can also reach many tens, or hundreds of metres. The width W, on the other hand, can be even greater than 1 metre, for example, it can be 2 metres, or more. Preferably the width W of the belt 10 is greater than 3 metres. The thickness S of the belt is greater than 3 millimetres and, in some embodiments, may even be greater than 25 millimetres.

The belt 10 comprises a first layer, or upper layer 11, configured to support, in use, the objects to be transported, a second layer, or intermediate layer 12, below and associated with the upper layer 11 and a mesh net 13 disposed, or embedded, at least inside the intermediate layer 12 (FIGS. 2 and 3).

By way of purely exemplary and non-limiting example, the upper layer 11 is made of a material selected from a group that comprises rubber, either natural or synthetic, such as anti-oil, anti-heat, anti-abrasive rubber, or silicone substances, fabric, felt, cotton or other.

However, it is clear that the material with which the upper layer 11 is made is selected according to the final application of the belt 10. For example, in the corrugated cardboard handling industry or the wood board handling industry, the upper layer 11 can be made of a natural and synthetic elastomer or NBR, SBR, EPDM/EPM, NR, CR, FKM, IIR, XIR, CSM, XNBR, HNBR rubber, silicone rubber, polyurethane and PVC.

It is clarified that, although in the example provided herein the upper layer 11 has been described as a single layer of a single material, in other possible embodiments, the upper layer 11 may also comprise two or more overlapping layers also consisting of different materials.

Furthermore, by way of non-limiting example, the intermediate layer 12 can be made of rubber, either natural or synthetic, such as nitrile rubber with a hardness of less than 50 shore, or natural rubber 40 shore.

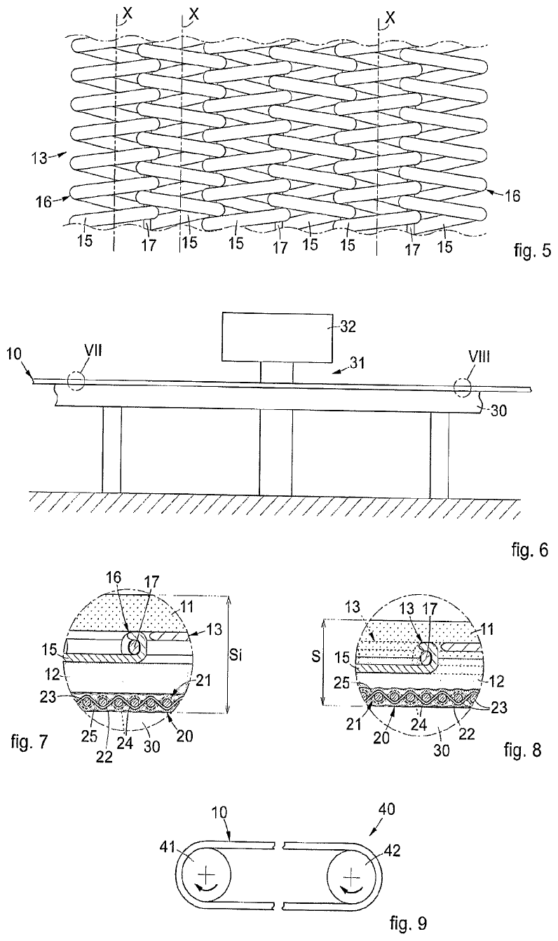

The mesh net 13 comprises a plurality of spiral yarns 15 (FIG. 5) disposed so that the respective longitudinal development axes X are substantially parallel to each other and to the width W of the belt 10.

The spiral yarns 15 are arranged side by side so as to alternate a spiral yarn 15 with clockwise longitudinal development with a spiral yarn 15 with counterclockwise longitudinal development.

Each spiral yarn 15 comprises, along its longitudinal extension axis X, a succession of turns 16 separated from each other by a pitch substantially equal to, or slightly greater than, the diameter of the spiral yarn 15 itself.

Adjacent spiral yarns 15 are coupled to each other by interleaving and overlapping the respective turns 16 and, in addition, a junction yarn 17 is inserted between the interleaved and overlapping turns 16.

By way of example only, the junction yarn 17 can be made of polyester.

According to an aspect of the present invention, the belt 10 also comprises a third layer, or lower layer 20, (FIGS. 2 and 3) adhering to the intermediate layer 12, configured to increase the rigidity of the belt 10 itself and which comprises a reinforcing material 21.

In the example provided herein, the reinforcing material 21 comprises a fabric 22 (FIG. 4) formed by weft and warp yarns.

In embodiments, the fabric 22 can include a plurality of first yarns 23, yarns disposed in the direction of the width W of the belt 10 and a plurality of second yarns 24 intertwined with the first yarns 23, and disposed in the direction of the length L of the belt 10.

In embodiments, the fabric 22 can be formed by yarns of natural fibres or synthetic fibres or artificial fibres or a combination thereof (i.e., a mixed fabric), e.g., natural and synthetic fibres or natural and artificial fibres or synthetic and artificial fibres or a combination of all three types of fibres.

An example of natural fibres is cotton. Thus, in a possible implementation, the fabric 22 may be formed by cotton fibre yarns, i.e. the fabric 22 may be cotton.

Examples of synthetic fibres are polyester and nylon (polyamide). Thus, in possible implementations, the fabric 22 can be formed by polyester and/or nylon fibre yarns, i.e. the fabric 22 can be polyester and/or nylon.

In embodiments, the first yarns 23 can be made of polyester and/or nylon and have a first diameter D1 comprised between about 0.05 mm and about 1.2 mm while the second yarns 24 are made of polyester and/or nylon and have a second diameter D2 comprised between about 0.5 mm and about 1.2 mm.

In addition, according to embodiments combinable with all embodiments described herein, the first yarns 23 are preferably more rigid than the second yarns 24. The different rigidity can be obtained, with the same type of fibre, by modifying the diameter (fibres of greater diameter will have greater rigidity and vice versa), or by modifying the type of fibre, with the same diameter, or a combination of such measures.

This makes it possible to provide high rigidity to the belt 10, especially in the direction of the width W, and to limit the deformation of the edges during use so as to ensure high stability of the planar shape of the belt 10 even after several cycles of use.

Optionally, the fabric 22 is at least partially disposed in, or embedded in, a gripping material 25 suitable for gripping the intermediate layer 12 by hot pressing, as will be explained below.

Preferably, the gripping material 25 into which the fabric 22 is embedded comprises a rubber, either natural or synthetic, selected from a group that comprises a natural or synthetic elastomer or NBR, SBR, EPDM/EPM, NR, CR, FKM, IIR, XIR, CSM, XNBR, HNBR rubber, silicone rubber, polyurethane and PVC.

Preferably, the tensile strength of the fabric 22, in the direction of the length L of the belt 10 is between about 1 kg/cm and about 80 kg/cm and is greater than the tensile strength of the mesh net 13 along the same direction.

Furthermore, the elastic constant of the fabric 22, in the direction of the length L of the belt 10, is comprised between about 0.5% and about 4%.

This allows to reduce, even by ten times, the elongation of the belt 10, along the direction of the length L, which occurs while using it due to mechanical stresses and thermal expansion.

Optionally, beneath the lower layer 20, a fourth layer, or adhesion layer 27, is disposed configured to increase the adhesion between the belt 10 and the rollers 41, 42 of a motorized conveyor 40 to which the belt 10 is applied.

The adhesion layer 27 may be continuous (not depicted) along the length L and the width W of the belt 10, and comprises a rubber, either natural or synthetic, selected from the group that comprises natural and synthetic elastomers and NBR, SBR, EPDM/EPM, NR, CR, FKM, IIR, XIR, CSM, XNBR, HNBR rubber, silicone rubber, polyurethane and PVC.

Alternatively, the adhesion layer 27 may have some solutions of continuity (FIG. 3) along the length L and/or the width W of the belt 10 at which the lower layer 20 is exposed.

In accordance with another aspect of the present invention, a method to produce the belt 10 described so far is preferably carried out by means of a forming machine, of a type known per se and which will not be described in detail, having a supporting plane 30 in which a pressing area 31 is defined on which a press 32 acts to perform a hot pressing (FIG. 6).

The method of the present invention envisages an optional step of impregnating the lower layer 20 in which the fabric 22 is impregnated with the gripping material 25.

Subsequently, the method envisages arranging the lower layer 20 on the supporting plane 30, and in particular by arranging at least one sector thereof at the pressing zone 31.

In addition, the method also envisages superimposing the intermediate layer 12, the mesh net 13 and the upper layer 11 on the lower layer 20 lying on the supporting plane 30.

In the example provided herein the mesh net 13 is disposed above the intermediate layer 12 which is in turn disposed in contact with the lower layer 20, however, in other embodiments, the mesh net 13 may be disposed below the intermediate layer 12 i.e. in contact with the lower layer 20.

It should be noted that in this step the lower layer 20, the intermediate layer 12, the mesh net 13 and the upper layer 11 are not permanently adhering to one another but only resting one on top of the other (FIG. 7) forming a layering assembly having an initial thickness Si greater than the thickness S of the belt 10.

The method envisages hot pressing together the lower layer 20, the intermediate layer 12, the mesh net 13 and the upper layer 11 by means of the hot press 32.

The aforesaid hot pressing is carried out with a pressure comprised between about 6 kg/cm² and about 12 kg/cm², a temperature comprised between 130° C. and about 170° C. and for a time comprised between about 5 seconds and about 30 minutes.

This makes it possible to embed the mesh net 13 at least in the intermediate layer 12 and to vulcanize the latter, and possibly also the upper layer 11 and the gripping layer 25. In particular, during hot pressing under the above-mentioned pressure, temperature and time conditions, the upper layer 11 and the intermediate layer 12 join together and the intermediate layer vulcanizes and permeates and incorporates at least part of the mesh net 13. In addition, the gripping layer 25 of the lower layer 20 vulcanizes by gripping and joining with the intermediate layer 12 (FIGS. 2, 3 and 8).

In the example provided herein, the hot pressing is carried out in a sectoral manner, that is, by hot pressing different sectors of the belt 10 from time to time by advancing the belt 10 on the supporting plane 30.

For example, at the end of a hot pressing step, the belt 10 is advanced with respect to the supporting plane 30 (FIG. 6) bringing a new sector of the belt 10, still not subjected to hot pressing, at the pressing zone 31. At this point, a new hot pressing is carried out on the new belt sector 10 present in the pressing zone 31.

Optionally, after the hot pressing, the method can include grinding the upper layer 11 of the belt 10 during which the latter is placed into contact with a rotating grinding abrasive roller (not depicted), to polish the surface of the upper layer 11.

The present invention also relates to a motorized conveyor 40 (FIG. 9) which includes a belt 10 as described herein, disposed endlessly around and at least two respective rollers 41, 42 of the aforesaid motorized conveyor 40.

According to embodiments, the aforesaid conveyor belt is wound in a loop around said at least two rollers. In essence, the motorized conveyor 40 comprises at least two rollers 41, 42 around which a belt 10 is wound in a loop in accordance with the present invention.

According to embodiments, the aforesaid belt 10 is disposed in a planar manner, without longitudinal twists, in said motorized conveyor 40.

It is clear that modifications and/or additions of parts can be made to the conveyor belt 10 and its production method described so far, without departing from the scope of the present invention as defined in the claims.

It is also clear that, although the present invention has been described with reference to some specific examples, a person skilled in the art will be able to make many other equivalent forms of conveyor belt having the features expressed in the claims and therefore all of which falling within the scope of protection defined thereby.

In the following claims, the references in parentheses have the sole purpose of facilitating reading and must not be considered as limiting factors of the scope of protection defined by the claims themselves.

1. A conveyer belt for transporting one or more objects, said conveyor belt comprising at least a first layer configured to support said one or more objects, a second layer associated with said first layer, and a mesh net disposed or embedded, at least partly, inside said second layer, wherein said conveyer belt also comprises a third layer adhering to said second layer on the opposite side with respect to said first layer and comprising at least one reinforcing material.

2. The conveyer belt of claim 1, wherein said reinforcing material comprises, or consists of, a fabric.

3. The conveyer belt as in of claim 1, wherein said reinforcing material is disposed or embedded, at least partly, in a gripping material comprising, or consisting of, a rubber, either natural or synthetic, selected from a group that comprises natural and synthetic elastomers and NBR, SBR, EPDM/EPM, NR, CR, FKM, IIR, XIR, CSM, XNBR, HNBR rubber, silicone rubber, polyurethane and PVC.

4. The conveyer belt of claim 2, wherein said fabric comprises a plurality of first yarns and a plurality of second yarns intertwined with said first yarns wherein said first yarns are more rigid than said second yarns.

5. The conveyer belt of claim 4, wherein said first yarns are disposed in the direction of the width (W) of said conveyor belt and that said second yarns are disposed in the direction of the length (L) of said conveyor belt, perpendicular to said direction of the width (W).

6. The conveyer belt of claim 4, wherein said fabric is formed by yarns of natural fibres or synthetic fibres or artificial fibres or combination thereof.

7. The conveyer belt of claim 6, wherein said natural fibres are cotton fibres.

8. The conveyer belt of claim 6, wherein said synthetic fibres are polyester and/or nylon fibres.

9. The conveyer belt of claim 4, wherein said first yarns are made of polyester and/or nylon and have a first diameter (D1) comprised between about 0.05 mm and about 1.2 mm and said second yarns are made of polyester and/or nylon and have a second diameter (D2) comprised between about 0.05 mm and about 1.2 mm.

10. The conveyer belt of one of the preceding claims, wherein said conveyer belt further comprises a fourth layer adhering to said third layer, on the opposite side with respect to said second layer and configured to contact means for advancing said conveyor belt which are present in a motorized conveyor.

11. A method to produce a conveyor belt having at least a first layer configured to support one or more objects, a second layer adhering to said first layer, a mesh net disposed, or embedded, at least partially, inside said second layer, and a third layer adhering to said second layer, on the opposite side with respect to said first layer and provided with at least one reinforcing material, said method comprising:
a first step in which said third layer is disposed on a supporting plane;
a second step in which said second layer is disposed on said third layer;
a third step in which said mesh net is coupled to at least said second layer;
a fourth step in which said first layer is disposed above said second layer and/or said mesh net;
a fifth step in which at least said first layer, said second layer, said mesh net and said third layer are hot pressed against each other.

12. The method as in claim 11, further comprising an impregnation step, preceding said first step, in which said reinforcing material is impregnated with a gripping material comprising, or consisting of, a rubber, either natural or synthetic, selected from a group that comprises natural and synthetic elastomers and NBR, SBR, EPDM/EPM, NR, CR, FKM, IIR, XIR, CSM, XNBR, HNBR rubber, silicone rubber, polyurethane and PVC.

13. The method of claim 11, wherein in said fifth step a pressure is applied comprised between about 6 kg/cm2 and about 12 kg/cm2, said layers are heated to a temperature comprised between about 130° C. and about 170° C. for a time comprised between about 5 seconds and about 30 minutes.

14. A motorized conveyor comprising at least one conveyor belt according to claim 1, or obtained by a method as in claim 11, disposed endlessly around and at least two respective rollers (41, 42) of said motorized conveyor (40).

15. The motorized conveyor of claim 14, wherein said conveyor belt is wound in a loop around said at least two rollers.

16. The motorized conveyor of claim 14, wherein said conveyor belt is disposed in a planar manner, without longitudinal twists, in said motorized conveyor.
